(19) United States
(12) Patent Application Publication
(10) Pub. No.: US 2023/0263682 A1
(43) Pub. Date: Aug. 24, 2023

(54) THORACIC MOBILITY SYSTEM, ADJUSTABLE THORACIC BENCH SYSTEM, AND METHOD OF USE

(71) Applicant: Jason Mitchler, Colorado Springs, CO (US)

(72) Inventor: Jason Mitchler, Colorado Springs, CO (US)

(21) Appl. No.: 17/677,669

(22) Filed: Feb. 22, 2022

(51) Int. Cl. A61G 13/00

(52) U.S. Cl. CPC A61G 13/009

(57) ABSTRACT

A thoracic mobility system, an adjustable thoracic bench system, and methods of use are presented. The present disclosure provides the state of the art with an adjustable thoracic mobility, extension and alignment bench with adjustable footrests for lumbar support. The systems increase mobility and alignment of the thoracic spine region while preventing excessive lordosis of the lumbar spine. The present disclosure provides a comfortable support with integrated thoracic mobility components designed for comfort and support to aid in mobility and alignment in a healthy and effective manner. The present disclosure provides these features and functionality while also providing a safe to use device, which increases spinal mobility, can be used to stretch, can be used to strengthen, and reduce stress of musculoskeletal structures, and the like.

### CROSS-REFERENCE TO RELATED APPLICATIONS

The present application claims priority to the U.S. Provisional Patent Application No. 63/276,729 which was filed on November 8, 2021, which is hereby incorporated by reference herein in its entirety, including any figures, tables, or drawings.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright. Jason Mitchler and Tyler Christiansen. All rights reserved.

### FIELD OF THE DISCLOSURE

This disclosure relates to a thoracic mobility system, an adjustable thoracic bench system, and methods of use. More specifically, and without limitation, the present disclosure relates to an adjustable thoracic mobility bench with adjustable footrests for lumbar support.

### BACKGROUND OF THE DISCLOSURE

The thoracic spine is the middle section of the spine and generally extends from approximately the bottom of the ribs to the base of the neck. The thoracic spine is the longest region of the spine. As alluded to above, the thoracic spine connects the cervical spine (or neck region) to the lumbar spine (or lower back).

Health of the thoracic spine is extremely important. In addition to protecting the spinal cord, the thoracic spine also stabilizes the rib cage. This entire structure, working in concert, protects the vital organs of the human anatomy, such as the heart and lungs. Stability in the thoracic spine is critical for these reasons. Contrasted with the cervical spine and lumbar spine, which are built for mobility, the thoracic spine is considered the anchor of the spine.

This anchor or stability feature can often cause stiffness and cause the thoracic spine to be less mobile than the cervical spine and lumbar spine. Complicating matters further, the thoracic spine has vertebrae that vary in size and shape, more so than the other parts of the spine. This allows for different ranges of motion and in different directions. For these reasons, care of the thoracic spine is often critical for comfort.

Mobility, alignment and extension of the thoracic spine are often needed to maintain overall stability of the spine. Furthermore, positioning and adjustments to the thoracic spine may be needed to create a comfortable spine, and alleviate pain. Thoracic spine adjustment comes in a variety of forms and may include professional care such as adjustments from a chiropractor. Various pieces of equipment or other home solutions have also recently entered the state of the art.

In recent times, some solutions for increasing the mobility, alignment, and extension of the thoracic spine have entered the market. Many of these solutions, however, can cause more problems than they solve. Said another way, some of the attempts to increase mobility, alignment and extension of the thoracic spine fail to meet the needs of the industry. Many current items require a person to place themselves on the floor. This can be a difficult task in itself for some of those who need treatment.

Yet, other equipment requires an uncomfortable position and/or presents a very unstable device for a user. Unstable devices along the upper back with no ability for a user to hold the device in place can be dangerous. Furthermore, unstable devices can also easily lead to excessive extension of the spine. Many existing devices cause excessive extension which can be damaging and uncomfortable, presenting more problems than are being solved.

Further, some recent equipment to enter the state of the art attempts to extend the thoracic spine through rolling and/or via a ball. These solutions are similarly ineffective and potentially dangerous. The amount of extension occurring, could again, be harmful based on the musculoskeletal needs of an individual. These various solutions fail to meet industry needs because they require an individual to place themselves in an uncomfortable and/or unachievable position. Furthermore, these adjustments are often more harmful than helpful due to the nature of the adjustment being provided.

Thus, there is a long-felt need in the art for an effective, safe, and easy to use system for increasing the mobility, alignment, and extension of the thoracic spine. Furthermore, there is a long felt need in the art for a composition and/or system that provides safe, easy to use adjustments for thoracic mobility, extension, and alignment. Furthermore, there is a need in the art for a system which can provide these benefits to individual musculoskeletal needs.

The disclosure herein provides these advantages and others as will become clear from the specification and claims provided.

### SUMMARY OF THE DISCLOSURE

A thoracic mobility system, an adjustable thoracic bench system, and methods of use. More specifically, and without limitation, the present disclosure relates to an adjustable thoracic mobility bench with adjustable footrests for lumbar support are presented.

The present disclosure advantageously provides the state of the art with solutions to the long felt needs is a safe, easy to use, and effective manner. The present disclosure provides an adjustable thoracic mobility, extension, and alignment system with adjustable features, including but not limited to, adjustable footrests. These adjustable features work in a stable manner, in concert with the system.

These features, used in concert, provide a stable platform with thoracic mobility components and footrest support so as to prevent excessive lumbar extension and meet individual musculoskeletal needs. In this way, the present disclosure provides the state of the art with an effective and safe thoracic mobility bench.

Thus, it is a primary object of the disclosure to provide a thoracic mobility system, an adjustable thoracic bench system, and methods of use which are effective, and safe to use.

Another object of the disclosure is to provide a thoracic mobility system, an adjustable thoracic bench system, and methods of use that are integrated, all in one system.

Yet another object of the disclosure is to provide a thoracic mobility system, an adjustable thoracic bench system, and methods of use that includes an integrated adjustable footrest support.

Another object of the disclosure is to provide a thoracic mobility system, an adjustable thoracic bench system, and methods of use that prevent excessive lumbar extension.

Yet another object of the disclosure is to provide a thoracic mobility system, an adjustable thoracic bench system, and methods of use that provide the ability to perform exercises off of the ground.

Another object of the disclosure is to provide a thoracic mobility system, an adjustable thoracic bench system, and methods of use that are accessible to those that can't get down to the ground easily.

Yet another object of the disclosure is to provide a thoracic mobility system, an adjustable thoracic bench system, and methods of use that provides effective treatment for those unable to position themselves due to musculoskeletal restrictions.

Another object of the disclosure is to provide a thoracic mobility system, an adjustable thoracic bench system, and methods of use that provides rehabilitation to those with musculoskeletal restrictions, need for rehabilitation, or limitations due to aging.

Yet another object of the disclosure is to provide a thoracic mobility system, an adjustable thoracic bench system, and methods of use that provides for the ability to adjust thoracic components of the device vertically or horizontally, as needed, for the needs of the musculoskeletal system of an individual.

Another object of the disclosure is to provide a thoracic mobility system, an adjustable thoracic bench system, and methods of use that provide an adjustable thoracic component.

Yet another object of the disclosure is to provide a thoracic mobility system, an adjustable thoracic bench system, and methods of use that provide adjustable footrests.

Another object of the disclosure is to provide a thoracic mobility system, an adjustable thoracic bench system, and methods of use that are user friendly.

Yet another object of the disclosure is to provide a thoracic mobility system, an adjustable thoracic bench system, and methods of use that adapt to a wide variety of musculoskeletal differences and/or restrictions.

Another object of the disclosure is to provide a thoracic mobility system, an adjustable thoracic bench system, and methods of use that are robust.

Yet another object of the disclosure is to provide a thoracic mobility system, an adjustable thoracic bench system, and methods of use that are durable.

Another object of the disclosure is to provide a thoracic mobility system, an adjustable thoracic bench system, and methods of use that are easy to use.

Yet another object of the disclosure is to provide a thoracic mobility system, an adjustable thoracic bench system, and methods of use that are safe to use.

These and other objects, features, or advantages of the present disclosure will become apparent from the specification and claims.

### BRIEF DESCRIPTION OF THE DRAWINGS

FIG. 1. is a top, perspective view; the view showing the thoracic mobility system, an adjustable thoracic bench system; the view showing a first bench; the view showing a second bench; the view showing a support system; the view showing a plurality of footrests; the view showing a thoracic adjustment feature; the view showing the thoracic mobility system in a down position.

FIG. 2. is a bottom, perspective view; the view showing the thoracic mobility system, an adjustable thoracic bench system; the view showing a first bench; the view showing a second bench; the view showing a support system; the view showing a plurality of footrests; the view showing a thoracic adjustment feature; the view showing the thoracic mobility system in a down position.

FIG. 3. is a top view; the view showing the thoracic mobility system, an adjustable thoracic bench system; the view showing parts of the support system in dashed lines; the view showing a first bench; the view showing a second bench; the view showing a support system; the view showing a plurality of footrests; the view showing a thoracic adjustment feature; the view showing the thoracic mobility system in a down position.

FIG. 4. is a side, elevation view; the view showing the thoracic mobility system, an adjustable thoracic bench system; the view showing parts of the support system in dashed lines; the view showing a first bench; the view showing a second bench; the view showing a support system; the view showing a plurality of footrests; the view showing a thoracic adjustment feature; the view showing the thoracic mobility system in a down position.

FIG. 5. is a top, side, elevation view; the view showing the thoracic mobility system, an adjustable thoracic bench system; the view showing parts of the support system in dashed lines; the view showing a first bench; the view showing a second bench; the view showing a support system; the view showing a plurality of footrests; the view showing a thoracic adjustment feature; the view showing the thoracic mobility system in a down position.

FIG. 6. is a top view; the view showing the thoracic mobility system, an adjustable thoracic bench system; the view showing parts of the support system in dashed lines; the view showing a first bench; the view showing a second bench; the view showing a support system; the view showing a plurality of footrests; the view showing a thoracic adjustment feature; the view showing the thoracic mobility system in a raised position.

FIG. 7. is a side, elevation view; the view showing the thoracic mobility system, an adjustable thoracic bench system; the view showing parts of the support system in dashed lines; the view showing a first bench; the view showing a second bench; the view showing a support system; the view showing a plurality of footrests; the view showing a thoracic adjustment feature; the view showing the thoracic mobility system in on of many options of a raised position.

FIG. 8. is a rear, elevation view; the view showing the thoracic mobility system, an adjustable thoracic bench system; the view showing parts of the support system in dashed lines; the view showing a first bench; the view showing a second bench; the view showing a support system; the view showing a plurality of footrests; the view showing a thoracic adjustment feature; the view showing the thoracic mobility system in a partially raised position.

FIG. 9. is a bottom, perspective view; the view showing the thoracic mobility system, an adjustable thoracic bench system; the view showing parts of the support system in dashed lines; the view showing a first bench; the view showing a second bench; the view showing a support system; the view showing a plurality of footrests; the view showing a thoracic adjustment feature; the view showing the thoracic mobility system in a partially raised position.

FIG. 10. is a top, isometric perspective view; the view showing the thoracic mobility system, an adjustable thoracic bench system; the view showing parts of the support system in dashed lines; the view showing a first bench; the view showing a second bench; the view showing a support system; the view showing a plurality of footrests; the view showing a thoracic adjustment feature; the view showing the thoracic mobility system in a down position.

FIG. 11. is a top, isometric perspective view; the view showing the thoracic mobility system, an adjustable thoracic bench system; the view showing parts of the support system in dashed lines; the view showing a first bench; the view showing a second bench; the view showing a support system; the view showing a plurality of footrests; the view showing a thoracic adjustment feature; the view showing the thoracic mobility system in a down position.

FIG. 12. is a bottom, perspective view; the view showing the thoracic mobility system, an adjustable thoracic bench system; the view showing a support system; the view showing the main bar of the support system; the view showing a plurality of attachment features; the view showing a plurality of adjustment features; the view showing ground supports of the support system.

FIG. 13. is a top, perspective view; the view showing the thoracic mobility system, an adjustable thoracic bench system; the view showing a support system; the view showing the main bar of the support system; the view showing a plurality of attachment features; the view showing a plurality of adjustment features; the view showing ground supports of the support system.

FIG. 14. is a top view; the view showing the thoracic mobility system, an adjustable thoracic bench system; the view showing a support system; the view showing the main bar of the support system; the view showing a plurality of attachment features; the view showing a plurality of adjustment features; the view showing ground supports of the support system.

FIG. 15. is a side, elevation view; the view showing the thoracic mobility system, an adjustable thoracic bench system; the view showing a support system; the view showing the main bar of the support system; the view showing a plurality of attachment features; the view showing a plurality of adjustment features; the view showing ground supports of the support system.

FIG. 16. is a top, elevation view; the view showing the thoracic mobility system, an adjustable thoracic bench system; the view showing a support system; the view showing the main bar of the support system; the view showing a plurality of attachment features; the view showing a plurality of adjustment features; the view showing ground supports of the support system.

FIG. 17. is a top, isometric, perspective view; the view showing the thoracic mobility system, an adjustable thoracic bench system; the view showing a support system; the view showing the main bar of the support system; the view showing a plurality of attachment features; the view showing a plurality of adjustment features; the view showing ground supports of the support system.

FIG. 18. is a bottom view; the view showing the thoracic mobility system, an adjustable thoracic bench system; the view showing a footrest with an attachment feature; the view showing a foot support.

FIG. 19. is a top, perspective view; the view showing the thoracic mobility system, an adjustable thoracic bench system; the view showing a footrest with an attachment feature; the view showing a foot support.

FIG. 20. is a top view; the view showing the thoracic mobility system, an adjustable thoracic bench system; the view showing a footrest with an attachment feature; the view showing a foot support.

FIG. 21. is a side view; the view showing the thoracic mobility system, an adjustable thoracic bench system; the view showing a footrest with an attachment feature; the view showing a foot support.

FIG. 22. is a top, perspective view; the view showing the thoracic mobility system, an adjustable thoracic bench system; the view showing a footrest with an attachment feature; the view showing a foot support.

FIG. 23. is a bottom view; the view showing the thoracic mobility system, an adjustable thoracic bench system; the view showing a footrest with an attachment feature; the view showing a foot support.

FIG. 24. is a side view; the view showing the thoracic mobility system, an adjustable thoracic bench system; the view showing a footrest with an attachment feature; the view showing a foot support.

FIG. 25. is a top view; the view showing the thoracic mobility system, an adjustable thoracic bench system; the view showing a footrest with an attachment feature; the view showing a foot support.

FIG. 26. is a top, isometric view; the view showing the thoracic mobility system, an adjustable thoracic bench system; the view showing a footrest with an attachment feature; the view showing a foot support.

FIG. 27. is a top, isometric view; the view showing the thoracic mobility system, an adjustable thoracic bench system; the view showing a footrest with an attachment feature; the view showing a foot support.

FIG. 28. is a top, perspective view; the view showing the thoracic mobility system, an adjustable thoracic bench system; the view showing a first bench support bar; the view showing attachment features of the support bar; the view showing adjustment features of the support bar.

FIG. 29. is a side, elevation view; the view showing the thoracic mobility system, an adjustable thoracic bench system; the view showing a first bench support bar; the view showing attachment features of the support bar; the view showing adjustment features of the support bar.

FIG. 30. is a top view; the view showing the thoracic mobility system, an adjustable thoracic bench system; the view showing a first bench support bar; the view showing attachment features of the support bar; the view showing adjustment features of the support bar.

FIG. 31. is a side elevation view; the view showing the thoracic mobility system, an adjustable thoracic bench system; the view showing a first bench support bar; the view showing attachment features of the support bar; the view showing adjustment features of the support bar.

FIG. 32. is a top, perspective view; the view showing the thoracic mobility system, an adjustable thoracic bench system; the view showing a first bench support bar; the view showing attachment features of the support bar; the view showing adjustment features of the support bar.

FIG. 33. is a top, isometric view; the view showing the thoracic mobility system, an adjustable thoracic bench system; the view showing a first bench support bar; the view showing attachment features of the support bar; the view showing adjustment features of the support bar.

FIG. 34. is a top, perspective view; the view showing the thoracic mobility system, an adjustable thoracic bench system; the view showing the first bench; the first bench having a padding on top.

FIG. 35. is a side elevation view; the view showing the thoracic mobility system, an adjustable thoracic bench system; the view showing the first bench; the first bench having a padding on top.

FIG. 36. is an elevation view; the view showing the thoracic mobility system, an adjustable thoracic bench system; the view showing the first bench; the first bench having a padding on top.

FIG. 37. is a bottom view; the view showing the thoracic mobility system, an adjustable thoracic bench system; the view showing the first bench; the first bench having a padding on top.

FIG. 38. is a top, perspective view; the view showing the thoracic mobility system, an adjustable thoracic bench system; the view showing the second bench; the view showing a padding on top.

FIG. 39. is a side view; the view showing the thoracic mobility system, an adjustable thoracic bench system; the view showing the second bench; the view showing a padding on top.

FIG. 40. is a side view; the view showing the thoracic mobility system, an adjustable thoracic bench system; the view showing the second bench; the view showing a padding on top.

FIG. 41. is a bottom view; the view showing the thoracic mobility system, an adjustable thoracic bench system; the view showing the second bench; the view showing a padding on top.

FIG. 42. is a top view; the view showing the thoracic mobility system, an adjustable thoracic bench system; the view showing the thoracic adjustment feature; the view showing the spinal guide; the view showing the first alignment feature; the view showing the second alignment feature.

FIG. 43. is a front view; the view showing the thoracic mobility system, an adjustable thoracic bench system; the view showing the thoracic adjustment feature; the view showing the spinal guide; the view showing the first alignment feature; the view showing the second alignment feature; the view showing an attachment feature; the view showing an adjustment feature.

FIG. 44. is a side, elevation view; the view showing the thoracic mobility system, an adjustable thoracic bench system; the view showing the thoracic adjustment feature; the view showing the spinal guide; the view showing the first alignment feature; the view showing the second alignment feature; the view showing an attachment feature; the view showing an adjustment feature.

FIG. 45. is a top, perspective view; the view showing the thoracic mobility system, an adjustable thoracic bench system; the view showing the thoracic adjustment feature; the view showing the spinal guide; the view showing the first alignment feature; the view showing the second alignment feature; the view showing an attachment feature; the view showing an adjustment feature.

FIG. 46. is a top, perspective, isometric view; the view showing the thoracic mobility system, an adjustable thoracic bench system; the view showing the thoracic adjustment feature; the view showing the spinal guide; the view showing the first alignment feature; the view showing the second alignment feature; the view showing an attachment feature; the view showing an adjustment feature.

FIG. 47. is a view showing the thoracic mobility system, an adjustable thoracic bench system; the view showing the support system; the view showing various adjustment features.

FIG. 48. is an elevation view showing the thoracic mobility system, an adjustable thoracic bench system; the view showing the support system; the view showing various adjustment features.

FIG. 49. is a top view showing the thoracic mobility system, an adjustable thoracic bench system; the view showing the support system; the view showing various adjustment features.

FIG. 50. is a side elevation view showing the thoracic mobility system, an adjustable thoracic bench system; the view showing the support system; the view showing various adjustment features.

FIG. 51. is a top, perspective view showing the thoracic mobility system, an adjustable thoracic bench system; the view showing the support system; the view showing various adjustment features.

FIG. 52. is a view showing the thoracic mobility system, an adjustable thoracic bench system; the view showing the support system; the view showing various adjustment features.

FIG. 53. is a view showing the thoracic mobility system, an adjustable thoracic bench system; the view showing the support system; the view showing various adjustment features.

FIG. 54. is a view showing the thoracic mobility system, an adjustable thoracic bench system; the view showing the support system; the view showing various adjustment features.

FIG. 55. is a view showing the thoracic mobility system, an adjustable thoracic bench system; the view showing the support system; the view showing various adjustment features.

FIG. 56. is a view showing the thoracic mobility system, an adjustable thoracic bench system; the view showing the support system; the view showing various adjustment features.

FIG. 57. is a view showing the thoracic mobility system, an adjustable thoracic bench system; the view showing the support system; the view showing various adjustment features.

FIG. 58. is a view showing portions of the thoracic mobility system, an adjustable thoracic bench system; the view showing the support system; the view showing a portion of the footrest system.

FIG. 59. is a view showing portions of the thoracic mobility system, an adjustable thoracic bench system; the view showing the support system; the view showing a portion of the footrest system.

FIG. 60. is a view showing portions of the thoracic mobility system, an adjustable thoracic bench system; the view showing the support system; the view showing a portion of the footrest system.

FIG. 61. is a view showing portions of the thoracic mobility system, an adjustable thoracic bench system; the view showing the support system; the view showing a portion of the footrest system.

FIG. 62. is a view showing portions of the thoracic mobility system, an adjustable thoracic bench system; the view showing the support system; the view showing a portion of the footrest system.

FIG. 63. is a view showing portions of the thoracic mobility system, an adjustable thoracic bench system; the view showing the support system; the view showing a portion of the footrest system.

FIG. 64. is a view showing portions of the thoracic mobility system, an adjustable thoracic bench system; the view showing the support system; the view showing a portion of the footrest system.

FIG. 65. is a view showing portions of the thoracic mobility system, an adjustable thoracic bench system; the view showing the support system; the view showing a portion of the footrest system.

FIG. 66. is a view showing portions of the thoracic mobility system, an adjustable thoracic bench system; the view showing the support system; the view showing a portion of the footrest system.

FIG. 67. is a view showing portions of the thoracic mobility system, an adjustable thoracic bench system; the view showing the support system; the view showing a portion of the footrest system.

FIG. 68. is a view showing portions of the thoracic mobility system, an adjustable thoracic bench system; the view showing the support system; the view showing a portion of the footrest system.

FIG. 69. is a view showing portions of the thoracic mobility system, an adjustable thoracic bench system; the view showing the support system; the view showing a portion of the footrest system.

FIG. 70. is a view showing portions of the thoracic mobility system, an adjustable thoracic bench system; the view showing the support system; the view showing a portion of the footrest system.

FIG. 71. is a view showing portions of the thoracic mobility system, an adjustable thoracic bench system; the view showing the support system; the view showing a portion of the footrest system.

FIG. 72. is a view showing portions of the thoracic mobility system, an adjustable thoracic bench system; the view showing the support system; the view showing a portion of the footrest system.

FIG. 73. is a view showing portions of the thoracic mobility system, an adjustable thoracic bench system; the view showing the support system; the view showing a portion of the footrest system.

FIG. 74. is a view showing portions of the thoracic mobility system, an adjustable thoracic bench system; the view showing the support system; the view showing a portion of the footrest system.

FIG. 75. is a view showing portions of the thoracic mobility system, an adjustable thoracic bench system; the view showing the support system; the view showing a portion of the footrest system.

FIG. 76. is a view showing portions of the thoracic mobility system, an adjustable thoracic bench system; the view showing the support system; the view showing a portion of the footrest system.

FIG. 77. is a view showing portions of the thoracic mobility system, an adjustable thoracic bench system; the view showing the support system; the view showing a portion of the footrest system.

FIG. 78. is a view showing portions of the thoracic mobility system, an adjustable thoracic bench system; the view showing the support system; the view showing a portion of the footrest system.

FIG. 79. is a view showing portions of the thoracic mobility system, an adjustable thoracic bench system; the view showing the support system; the view showing a portion of the footrest system.

FIG. 80. is a view showing portions of the thoracic mobility system, an adjustable thoracic bench system; the view showing the support system; the view showing a portion of the footrest system.

FIG. 81. is a view showing portions of the thoracic mobility system, an adjustable thoracic bench system; the view showing the support system; the view showing a portion of the footrest system.

FIG. 82. is a view showing portions of the thoracic mobility system, an adjustable thoracic bench system; the view showing the support system; the view showing a portion of the footrest system.

FIG. 83. is a view showing portions of the thoracic mobility system, an adjustable thoracic bench system; the view showing the support system; the view showing a portion of the footrest system.

FIG. 84. is a view showing portions of the thoracic mobility system, an adjustable thoracic bench system; the view showing the support system; the view showing a portion of the footrest system.

FIG. 85. is a view showing portions of the thoracic mobility system, an adjustable thoracic bench system; the view showing the support system; the view showing a portion of the footrest system.

FIG. 86. is a view showing portions of the thoracic mobility system, an adjustable thoracic bench system; the view showing the support system; the view showing a portion of the footrest system.

FIG. 87. is a view showing portions of the thoracic mobility system, an adjustable thoracic bench system; the view showing the support system; the view showing a portion of the support system; the view showing adjustment features for the support system; the view showing various attachment features.

FIG. 88. is a view showing portions of the thoracic mobility system, an adjustable thoracic bench system; the view showing the support system; the view showing a portion of the support system; the view showing adjustment features for the support system; the view showing various attachment features.

FIG. 89. is a view showing portions of the thoracic mobility system, an adjustable thoracic bench system; the view showing the support system; the view showing a portion of the support system; the view showing adjustment features for the support system; the view showing various attachment features.

FIG. 90. is a view showing portions of the thoracic mobility system, an adjustable thoracic bench system; the view showing the support system; the view showing a portion of the support system; the view showing adjustment features for the support system; the view showing various attachment features.

FIG. 91. is a view showing portions of the thoracic mobility system, an adjustable thoracic bench system; the view showing the support system; the view showing a portion of the support system; the view showing adjustment features for the support system; the view showing various attachment features.

FIG. 92. is a view showing portions of the thoracic mobility system, an adjustable thoracic bench system; the view showing the support system; the view showing a portion of the support system; the view showing adjustment features for the support system; the view showing various attachment features.

FIG. 93. is a view showing portions of the thoracic mobility system, an adjustable thoracic bench system; the view showing the support system; the view showing a portion of the support system; the view showing adjustment features for the support system; the view showing various attachment features.

FIG. 94. is a view showing portions of the thoracic mobility system, an adjustable thoracic bench system; the view showing the support system; the view showing a portion of the support system; the view showing adjustment features for the support system; the view showing various attachment features.

FIG. 95. is a view showing portions of the thoracic mobility system, an adjustable thoracic bench system; the view showing the support system; the view showing a portion of the support system; the view showing adjustment features for the support system; the view showing various attachment features.

FIG. 96. is a view showing portions of the thoracic mobility system, an adjustable thoracic bench system; the view showing the support system; the view showing a portion of the support system; the view showing adjustment features for the support system; the view showing various attachment features.

FIG. 97. is a view showing portions of the thoracic mobility system, an adjustable thoracic bench system; the view showing the support system; the view showing a portion of the support system; the view showing adjustment features for the support system; the view showing various attachment features.

FIG. 98. is a view showing portions of the thoracic mobility system, an adjustable thoracic bench system; the view showing the support system; the view showing a portion of the support system; the view showing adjustment features for the support system; the view showing various attachment features.

FIG. 99. is a view showing portions of the thoracic mobility system, an adjustable thoracic bench system; the view showing the support system; the view showing a portion of the support system; the view showing adjustment features for the support system; the view showing various attachment features.

FIG. 100. is a view showing portions of the thoracic mobility system, an adjustable thoracic bench system; the view showing the support system; the view showing a portion of the support system; the view showing adjustment features for the support system; the view showing various attachment features.

FIG. 101. is a view showing portions of the thoracic mobility system, an adjustable thoracic bench system; the view showing the support system; the view showing a portion of the support system; the view showing adjustment features for the support system; the view showing various attachment features.

FIG. 102. is a view showing portions of the thoracic mobility system, an adjustable thoracic bench system; the view showing the support system; the view showing a portion of the support system; the view showing adjustment features for the support system; the view showing various attachment features.

FIG. 103. is a view showing portions of the thoracic mobility system, an adjustable thoracic bench system; the view showing the support system; the view showing a portion of the support system; the view showing adjustment features for the support system; the view showing various attachment features.

FIG. 104. is a view showing portions of the thoracic mobility system, an adjustable thoracic bench system; the view showing the support system; the view showing a portion of the support system; the view showing adjustment features for the support system; the view showing various attachment features.

FIG. 105. is a view showing portions of the thoracic mobility system, an adjustable thoracic bench system; the view showing a portion of the thoracic adjustment feature; the view showing the bottom plate of the thoracic adjustment feature; the view showing the connection plate between the alignment features and the adjustment features.

FIG. 106. is a view showing portions of the thoracic mobility system, an adjustable thoracic bench system; the view showing a portion of the thoracic adjustment feature; the view showing the bottom plate of the thoracic adjustment feature; the view showing the connection plate between the alignment features and the adjustment features.

FIG. 107. is a view showing portions of the thoracic mobility system, an adjustable thoracic bench system; the view showing a portion of the thoracic adjustment feature; the view showing the bottom plate of the thoracic adjustment feature; the view showing the connection plate between the alignment features and the adjustment features.

FIG. 108. is a view showing portions of the thoracic mobility system, an adjustable thoracic bench system; the view showing a portion of the thoracic adjustment feature; the view showing the spinal guide feature; the view showing the first alignment feature; the view showing the second alignment feature.

FIG. 109. is a view showing portions of the thoracic mobility system, an adjustable thoracic bench system; the view showing a portion of the thoracic adjustment feature; the view showing the spinal guide feature; the view showing the first alignment feature; the view showing the second alignment feature.

FIG. 110. is a view showing portions of the thoracic mobility system, an adjustable thoracic bench system; the view showing a portion of the thoracic adjustment feature; the view showing the spinal guide feature; the view showing the first alignment feature; the view showing the second alignment feature.

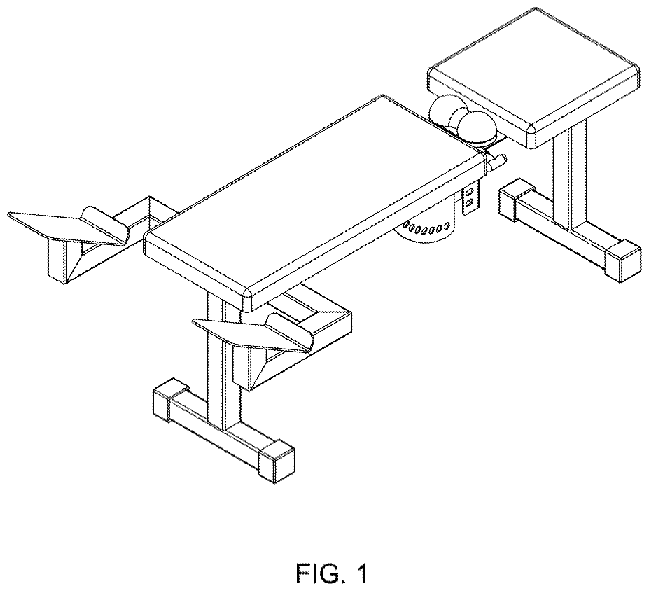

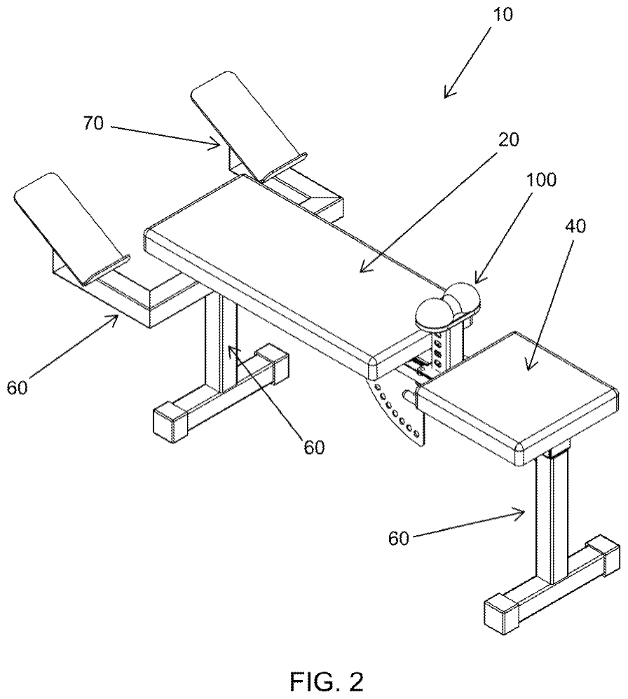

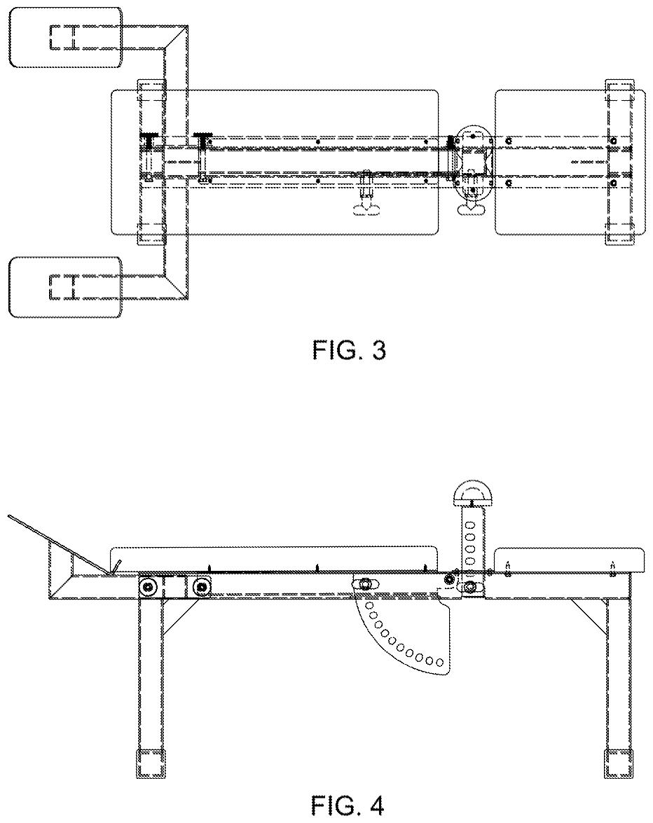

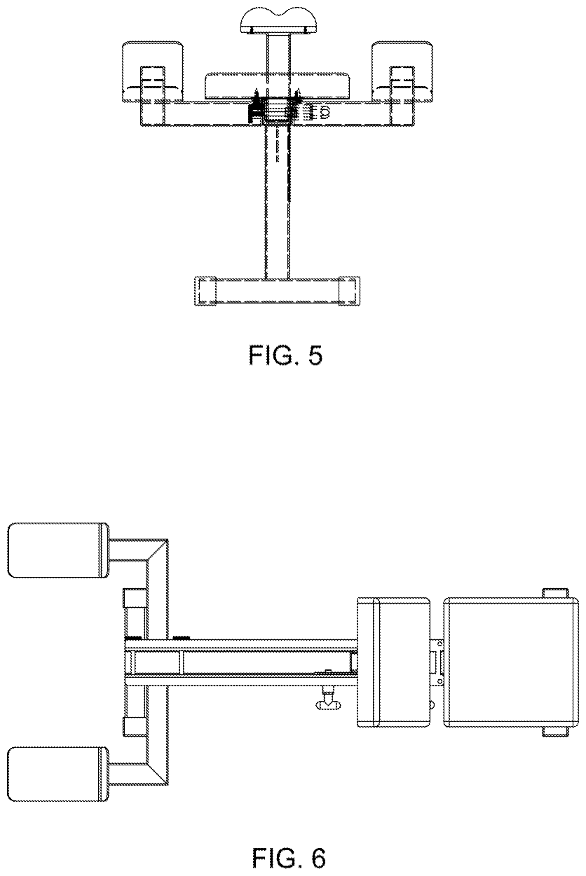

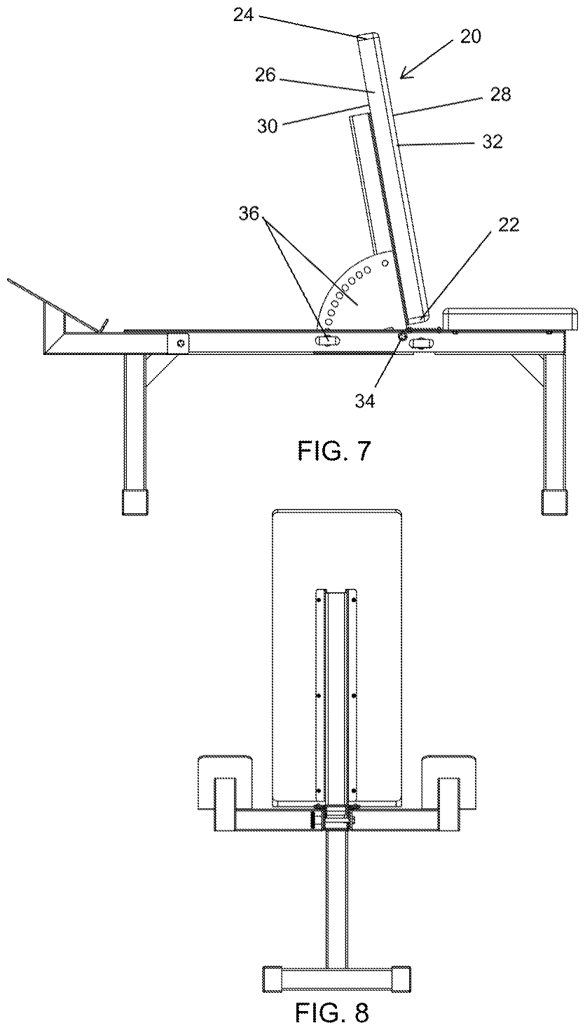

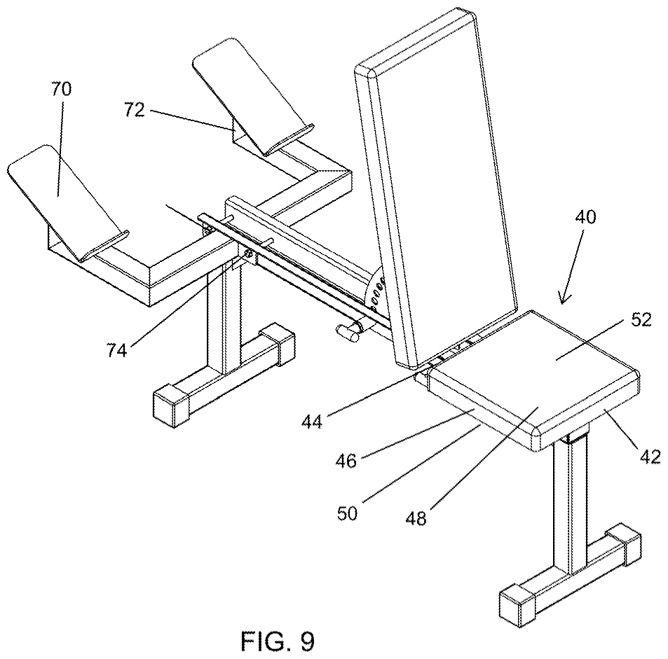

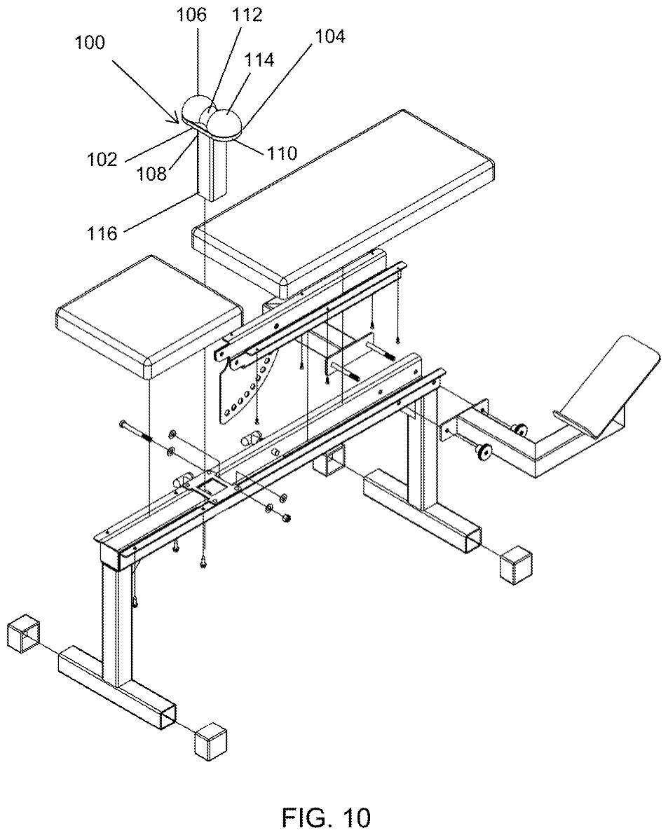

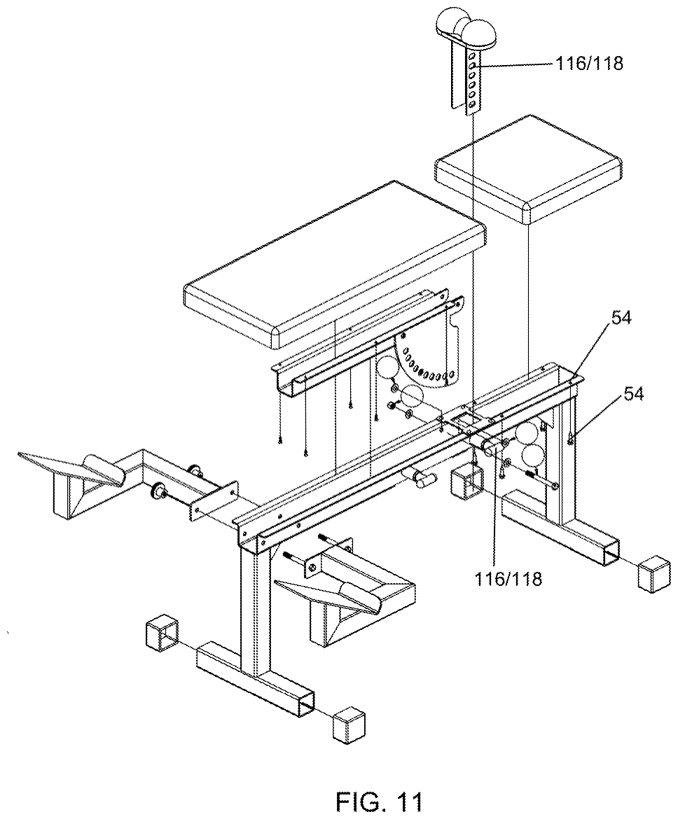

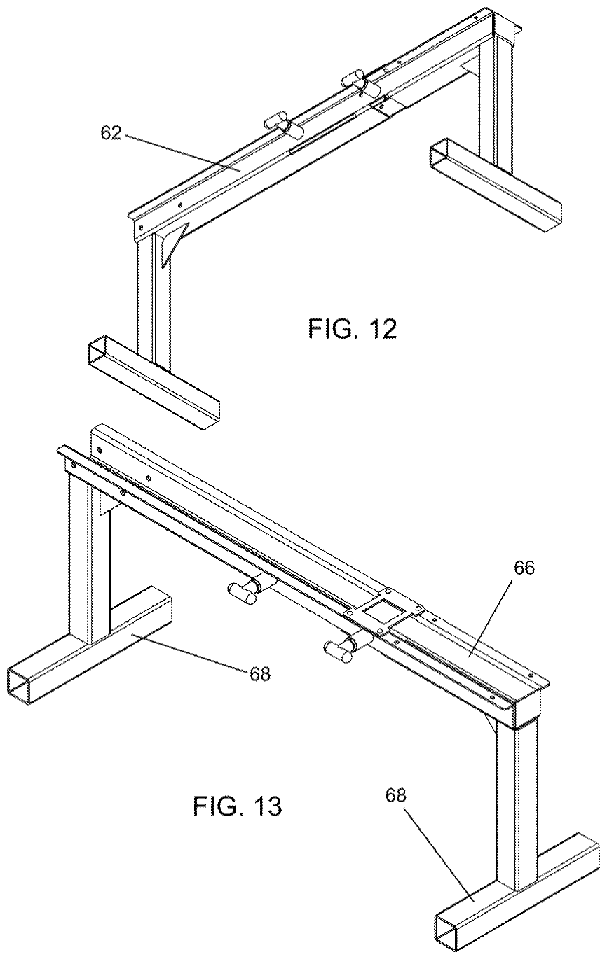

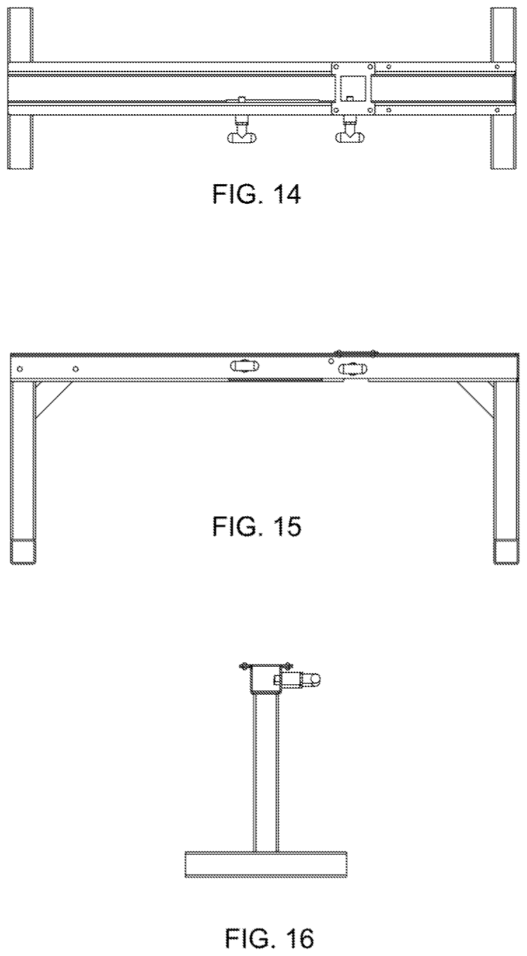

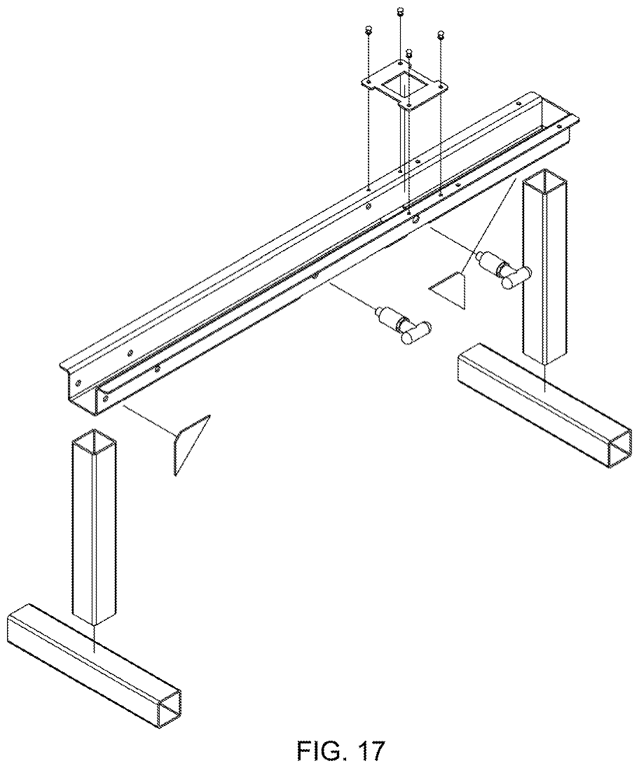

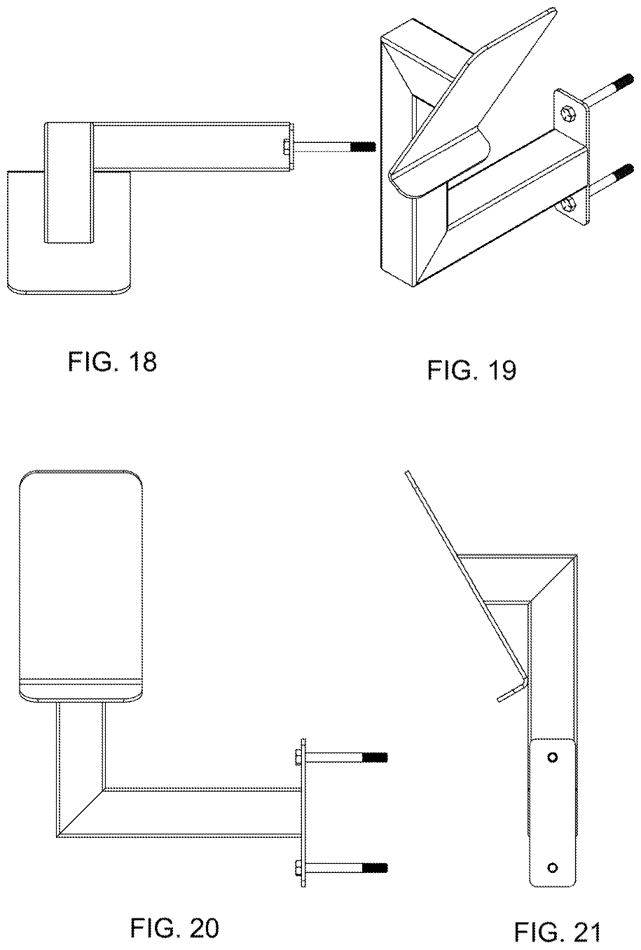

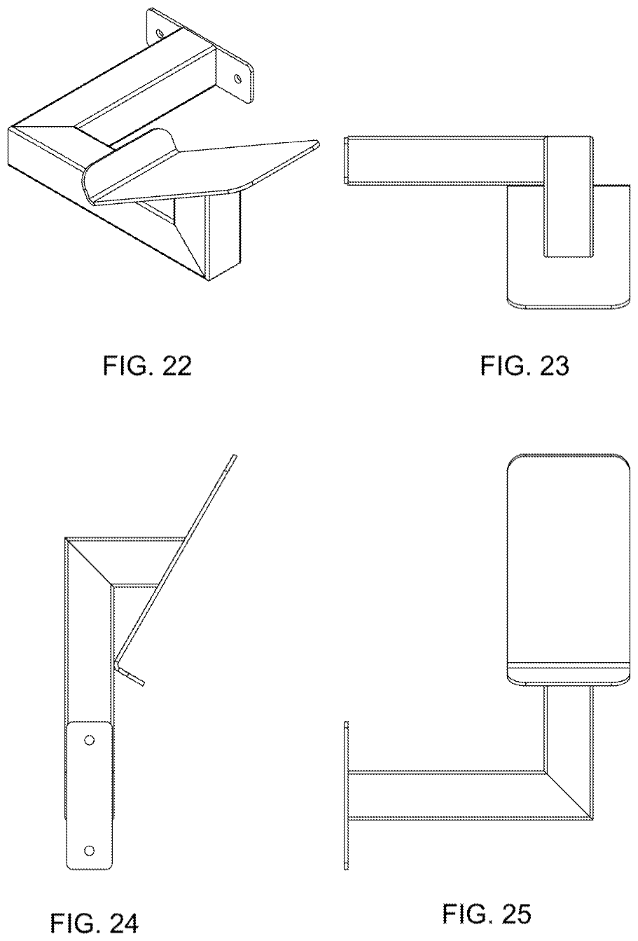

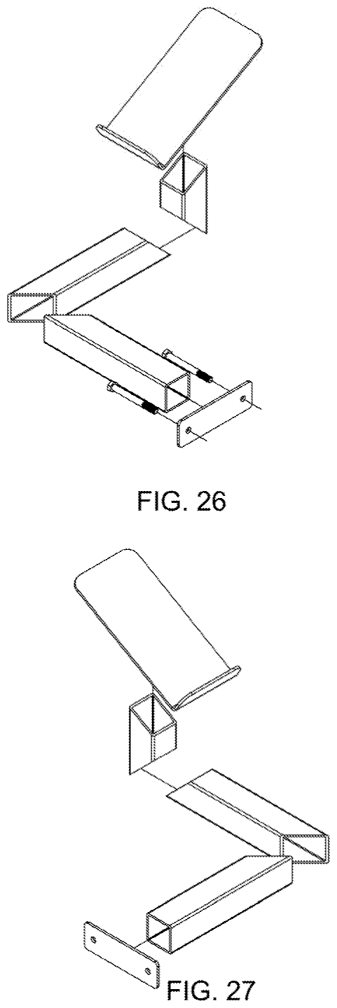

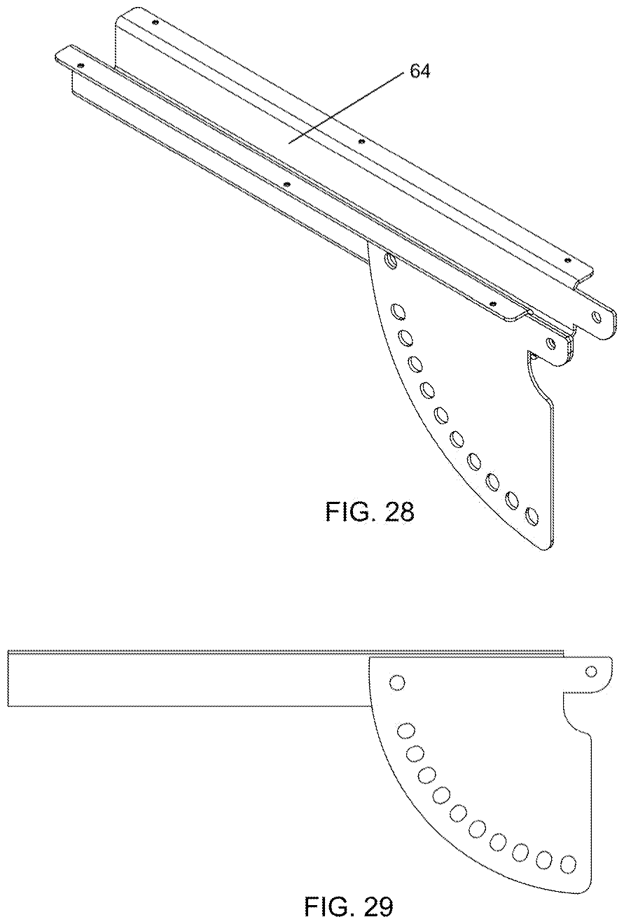

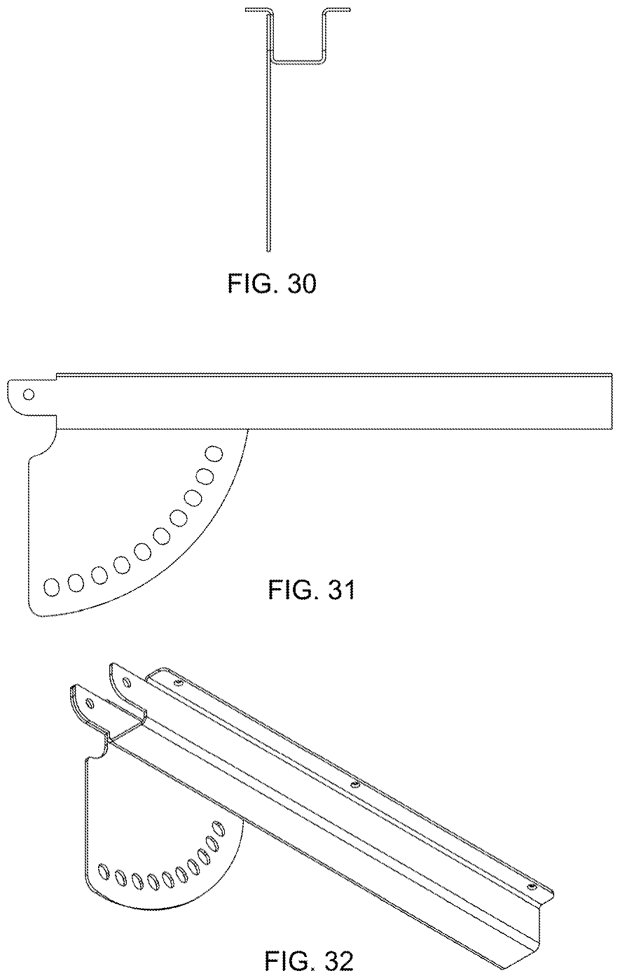

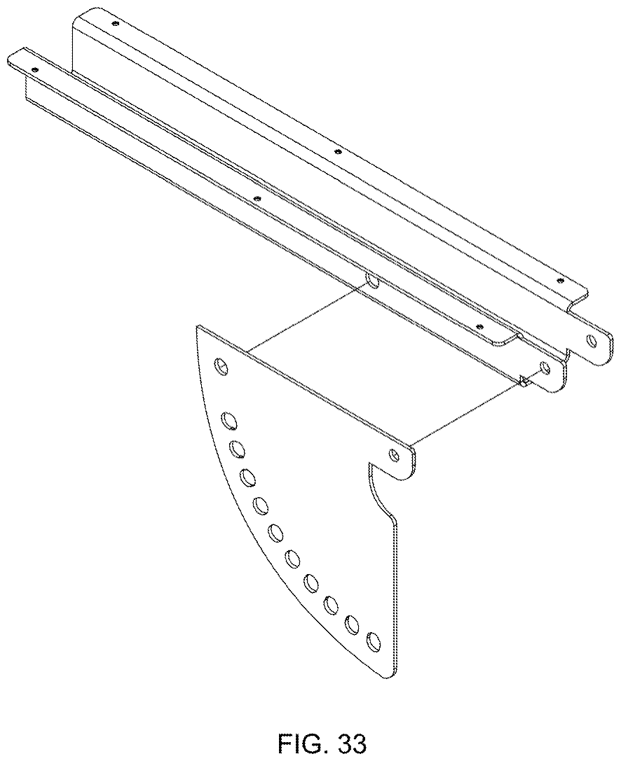

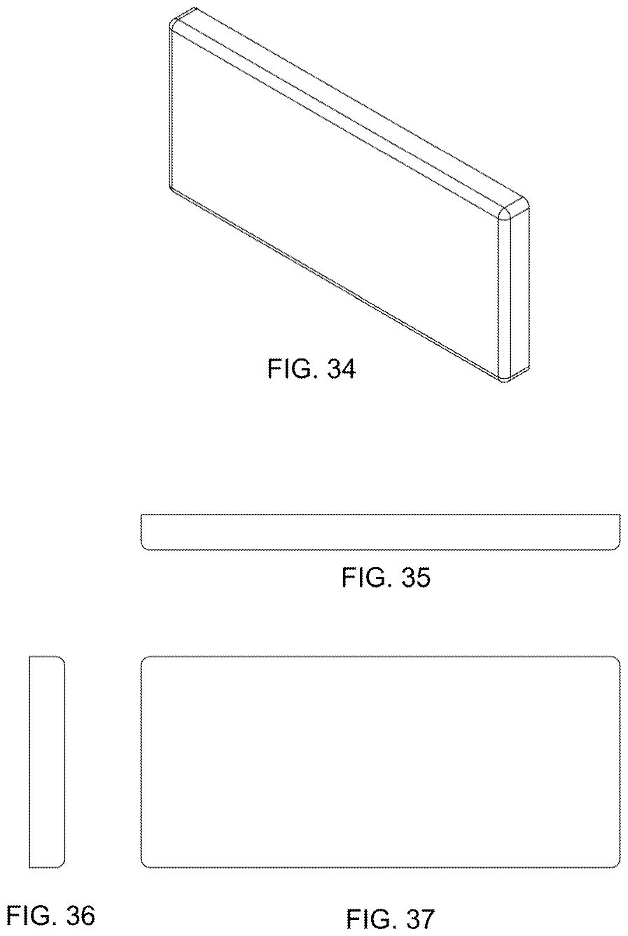

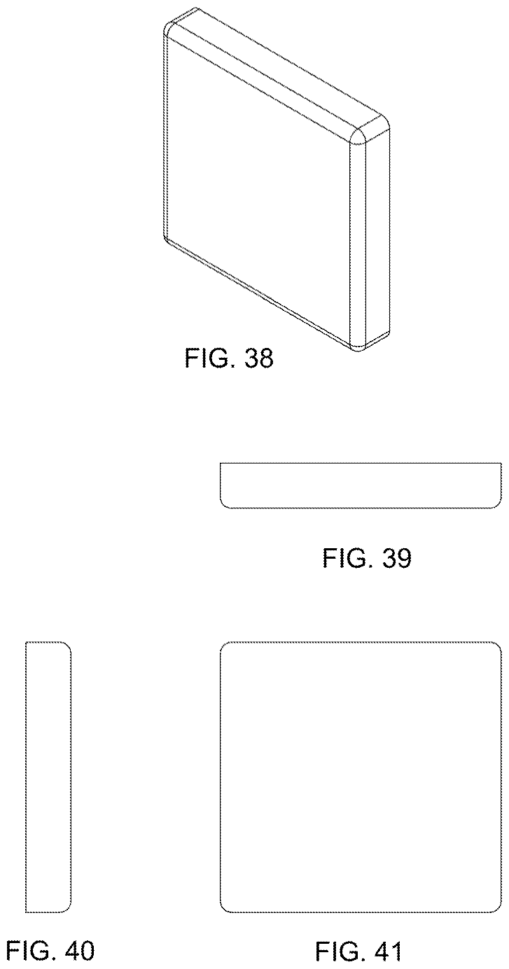

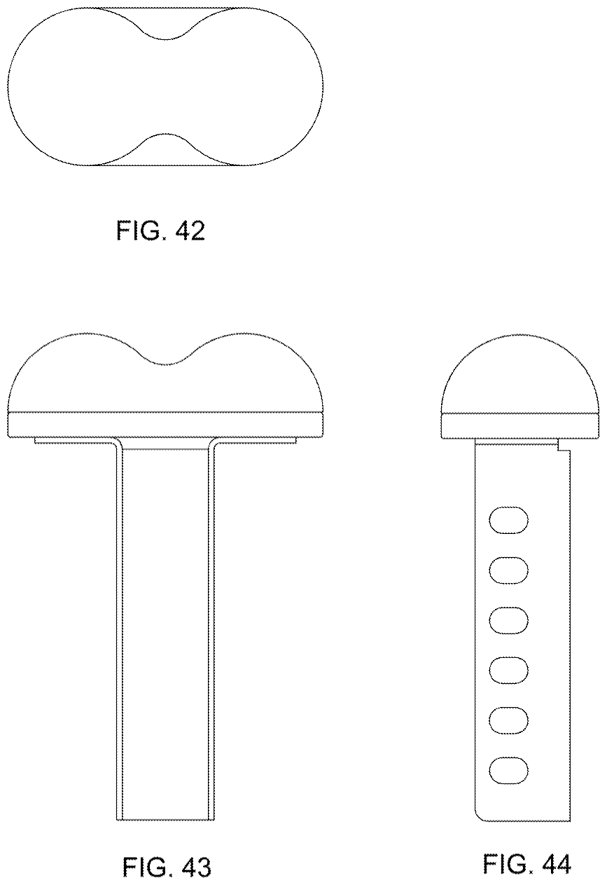

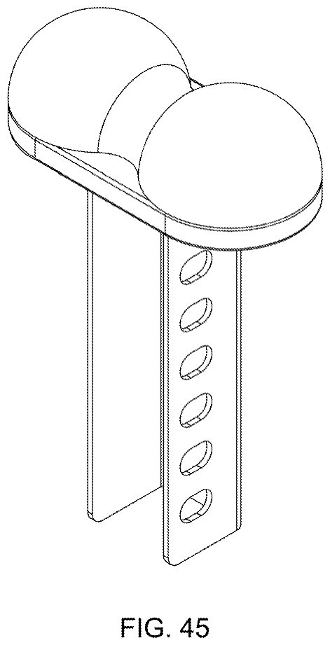

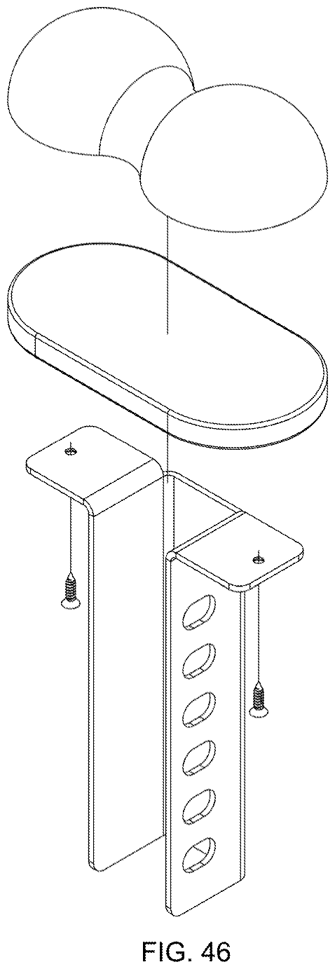

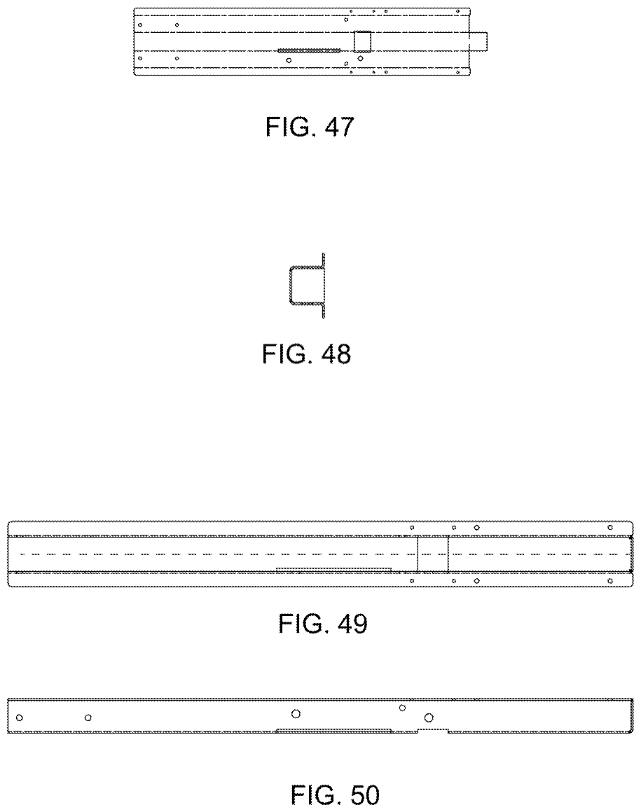

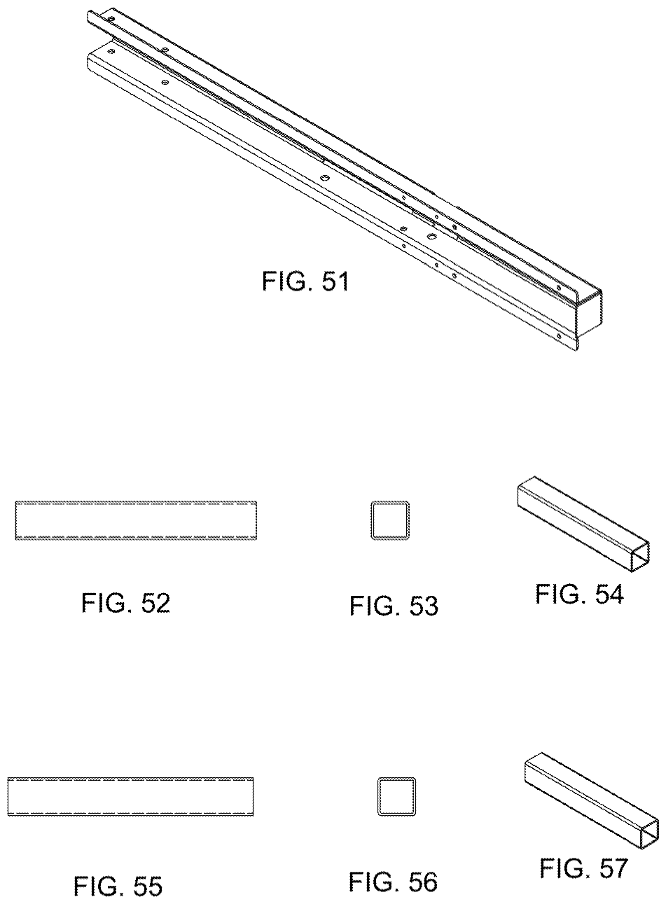

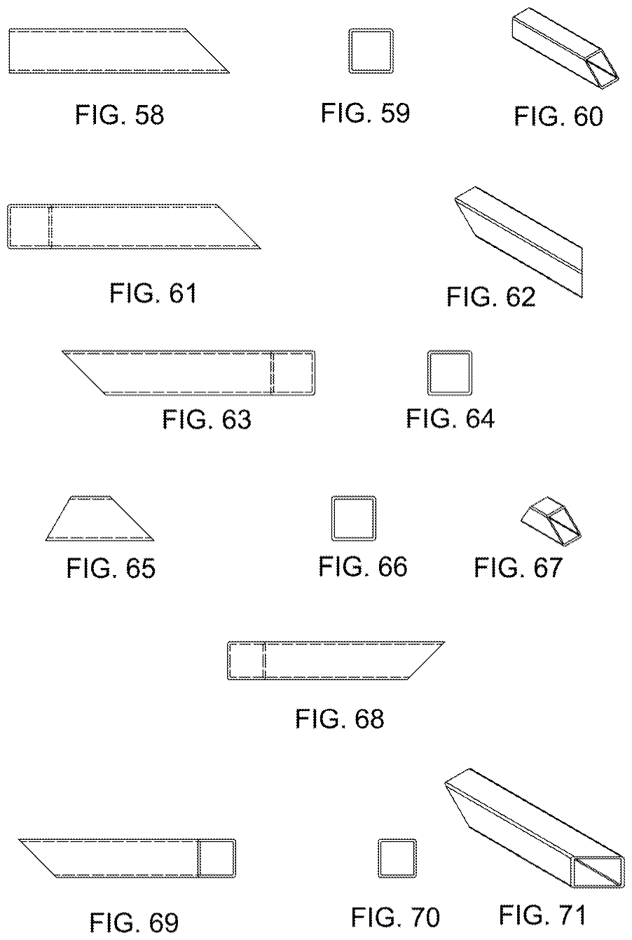

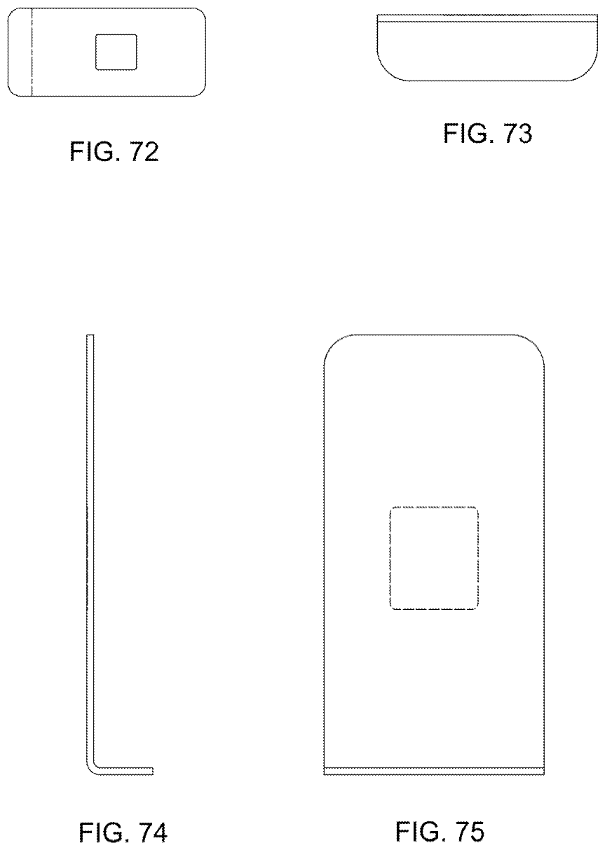

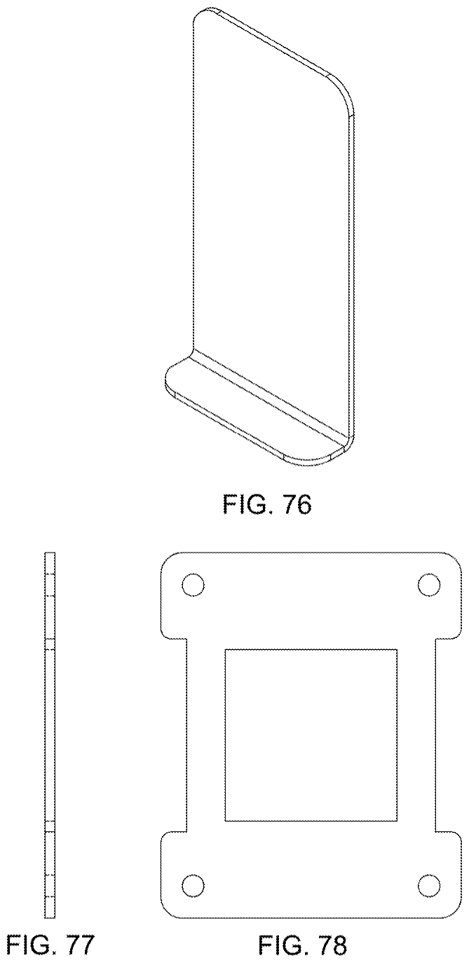

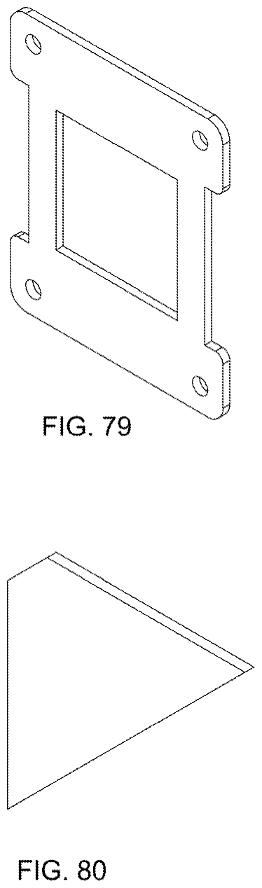

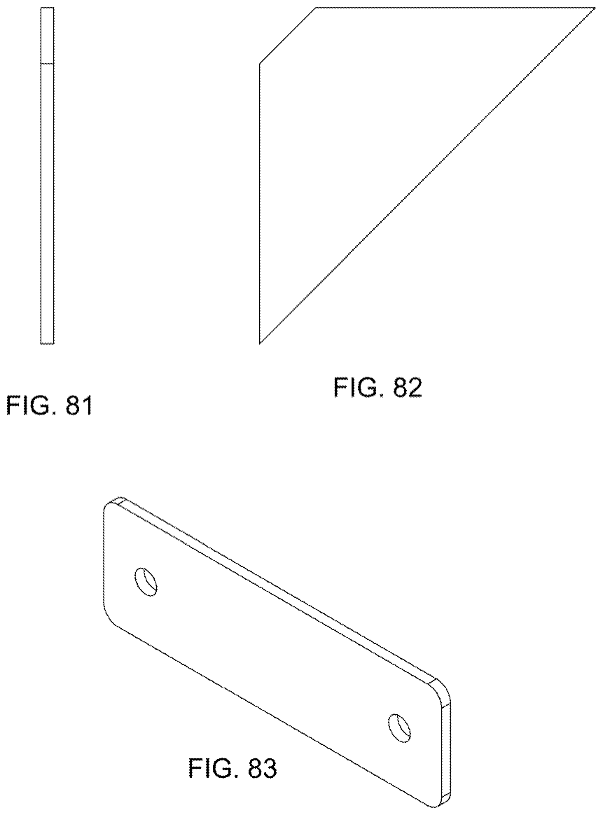

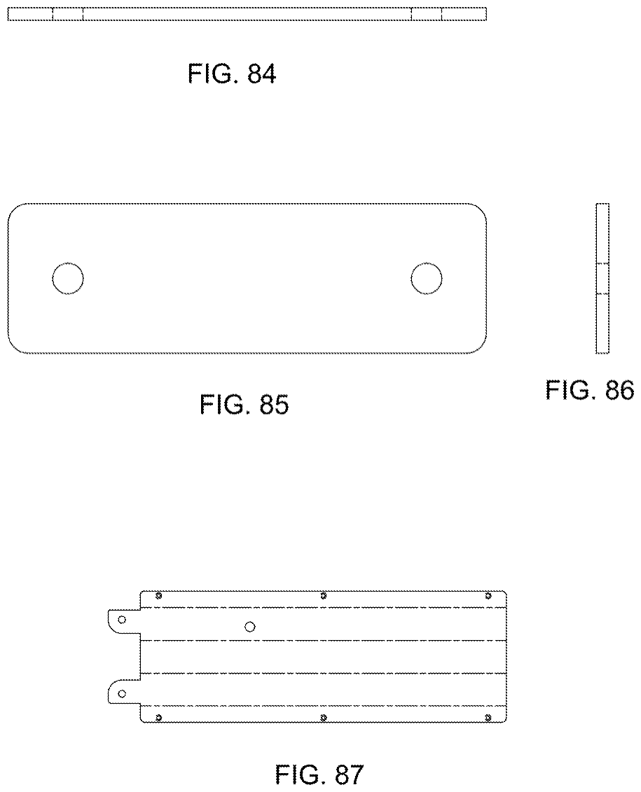

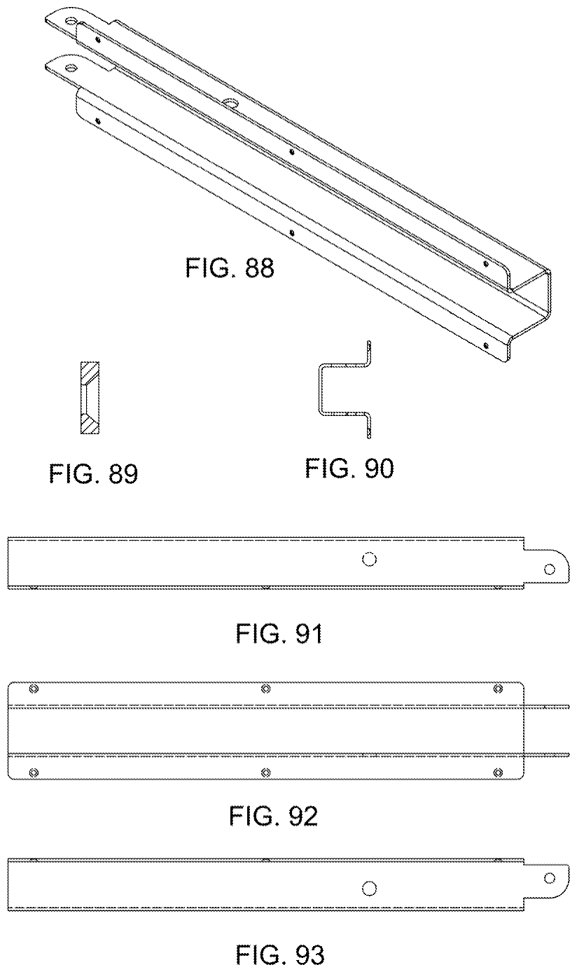

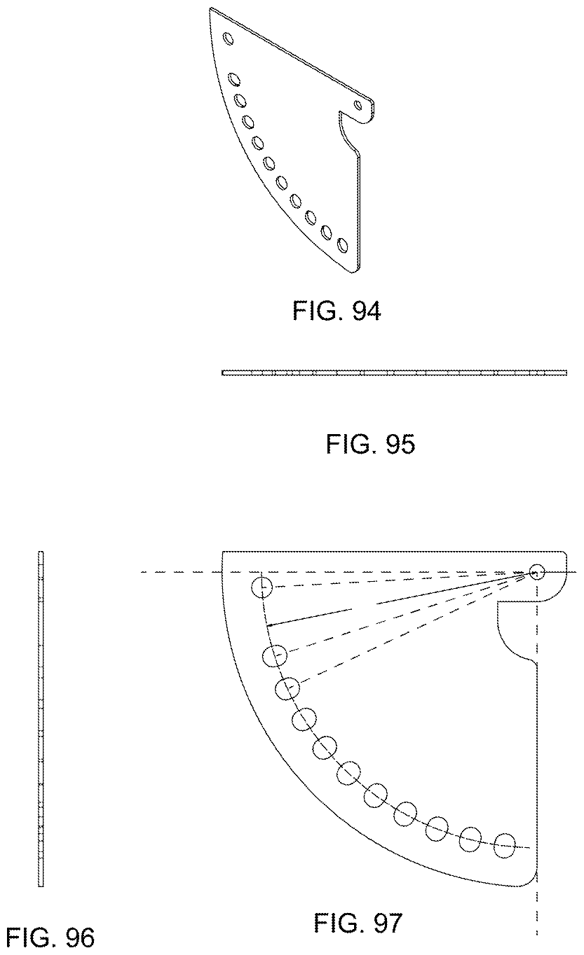

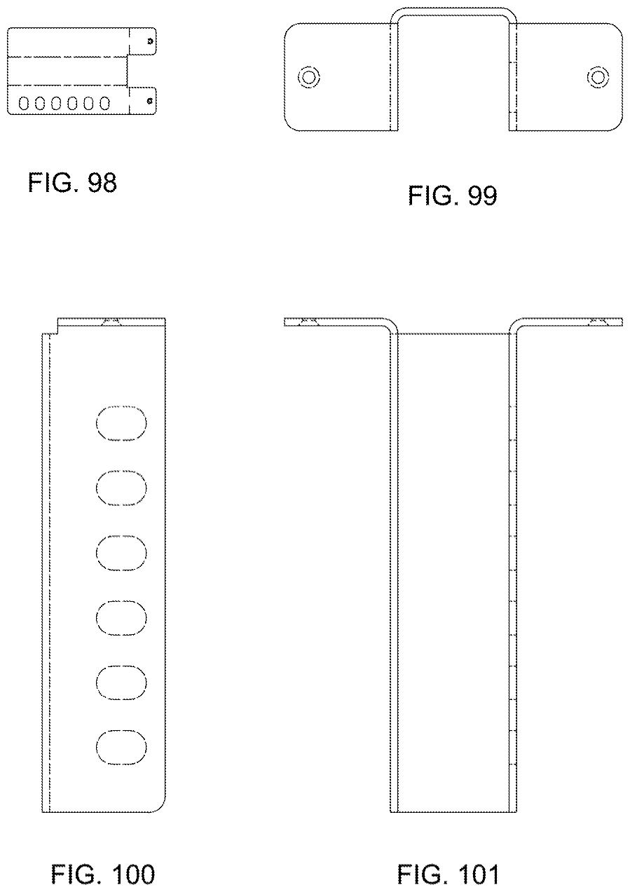

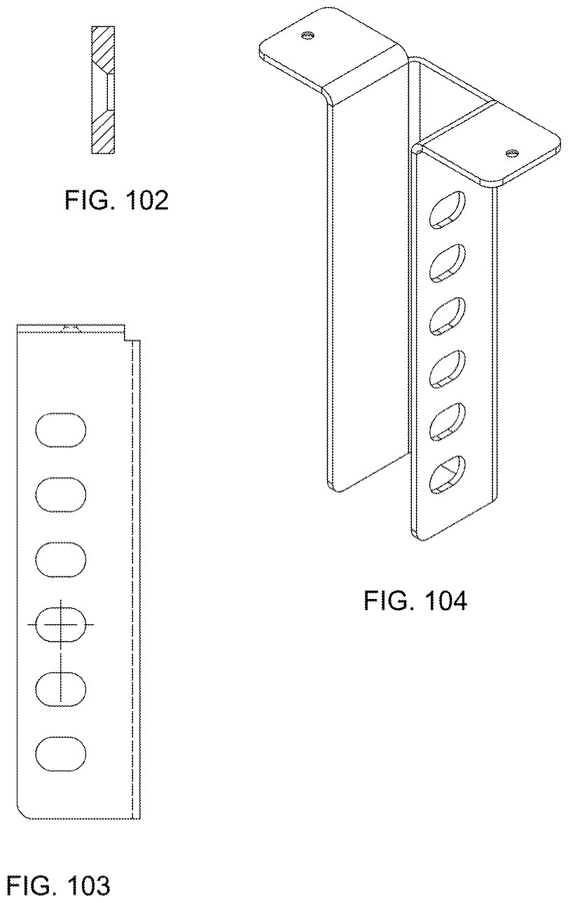

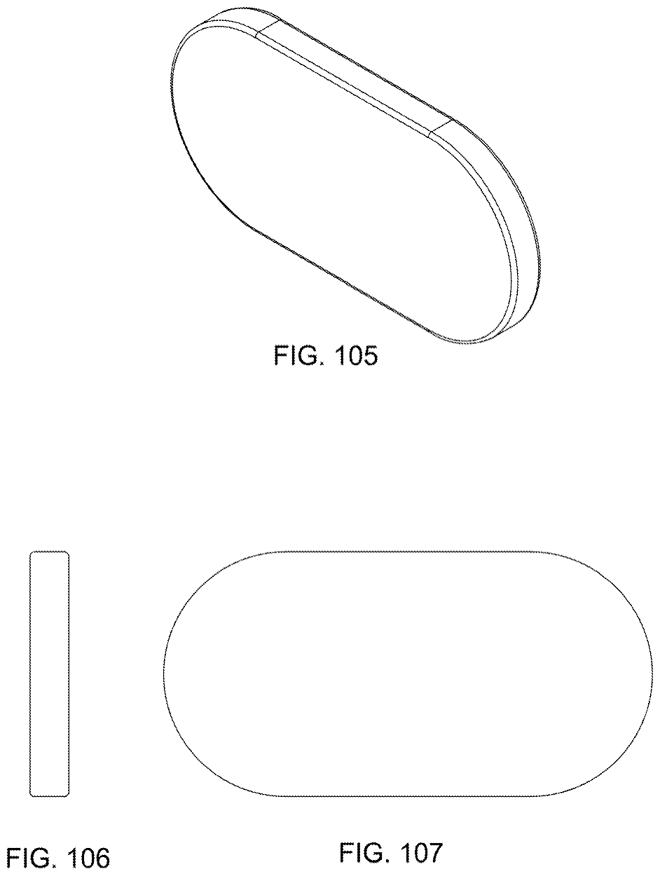

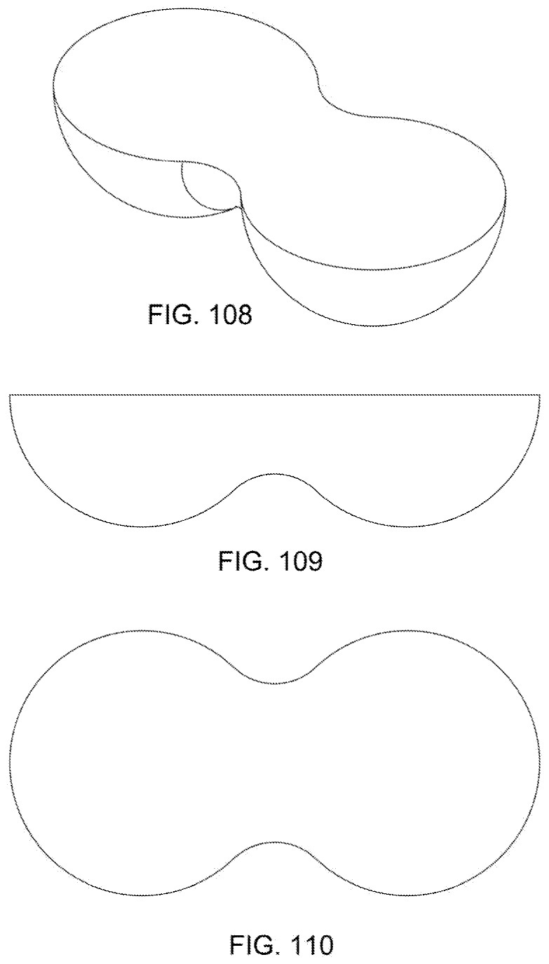

### DETAILED DESCRIPTION OF THE DISCLOSURE:

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

System:

With reference to the figures, a thoracic mobility system, an adjustable thoracic bench system, and methods of use 10 (hereafter referred to as “thoracic mobility system”, “thoracic spine alignment system”, “musculoskeletal health system”, “spine alignment system”, or simply “system”) is formed of any suitable size, shape and design.

In the arrangement shown, as one example, system 10 is configured to provides an adjustable thoracic mobility, extension and alignment bench with adjustable footrests for lumbar support. System 10 includes features for aiding in increased mobility and alignment of the thoracic spine region while preventing excessive lordosis of the lumbar spine. Furthermore, system 10 is configured to provide a comfortable support with integrated thoracic mobility components designed for comfort and support to aid in mobility and alignment in a healthy and effective manner. System 10, as will become more apparent from the present disclosure, provides these features and functionality while also providing a safe to use device, which increases spinal mobility, can be used to stretch, can be used to strengthen, and reduce stress of musculoskeletal structures, and the like.

In the arrangement shown, as one example, thoracic mobility system 10 includes, in the embodiment(s) depicted, a main body or main bench 20, a secondary bench or top bench 40, a support system 60, and an adjustable thoracic feature 100, among other components, features, and functions.

User (or plurality thereof):

In the arrangement shown, as one example, system 10 may include a user. Users may be any user interacting with or utilizing the system 10. This may include viewing, controlling, analyzing, manipulating, and/or interacting with system 10. Users are not limited to a single user but may be a plurality of users. Furthermore, a user is not limited to a user engaging with and/or exercising with system 10. Users may also include an instructor such as a medical professional. This medical professional may be a physical therapist, a medical doctor, an assistant, and the like.

Main body:

In the arrangement shown, as one example, system 10 includes a main body 20 (also referred to as “Primary Bench”, “First Bench”, or simply “Bench”). First bench 20 is formed of any suitable size, shape, and design, and is configured to support the main body of a user. Said another way, first bench 20 serves as a support bench. A user will lay down on the bench with their back on the bench, partially, in one method of use.

In the arrangement shown, as one example, the main body 20 extends a length from a first end 22 to a second end 24 between opposing sides 26. In the arrangement shown, the first bench includes a top 28 with a padding component 32, a bottom 30, a plurality of attachment features 34 and a plurality of adjustment features 36.

In the arrangement shown, as one example, first bench 20 is formed of a bench in an approximate rectangular shape and/or orientation—having a cranial side, a caudal side, a right side, a left side, a top and bottom (as is further described herein). The opposing sides 26 are in approximate parallel space relations to one another. In the arrangement shown, as one example, the top 28 of the bench is padded for comfort and support. Furthermore, the top includes a center opening near the cranial side of the bench.

In the arrangement shown, as one example, the first bench is also operably connected to a support beam (support system to be further described herein). The support beam for the first bench, in one embodiment, is in the approximate center bottom so as to support safely and securely the first bench 20.

Second body:

In the arrangement shown, as one example, system 10 includes a second body 40 (also referred to as “Secondary Bench”, “Second Bench”, or simply “Bench”). Second bench 40 is formed of any suitable size, shape, and design, and is configured to support a user when a user engages and/or partially engages with the second bench 40. Said another way, second bench 40 serves as a support bench. A user will lay down on the bench with their back on the bench, partially, in one method of use.

In the arrangement shown, as one example, the second bench 40 extends a length from a first end 42 to a second end 44 between opposing sides 46. In the arrangement shown, the first bench includes a top 48 with a padding component 52, a bottom 50, a plurality of attachment features 54 and a plurality of adjustment features.

In the arrangement shown, as one example, the second bench 40 is arranged adjacent to the first bench 20 in a precise spaced relationship such that the adjustable thoracic feature 100 can be configured between the two. In this way, the first bench and the second bench work in concert with the thoracic feature 100, as is further described and illustrated in this disclosure.

In the arrangement shown, as one example, second bench 40 is formed of a bench in an approximate square shape, having a cranial side, a caudal side, a right side, a left side, a top and bottom (as is further described herein). The opposing sides 46 are in approximate parallel space relations to one another. In the arrangement shown, as one example, the top 48 of the bench is padded for comfort and support. Furthermore, the top includes a center opening near the cranial side of the bench.

In the arrangement shown, as one example, the first bench is also operably connected to a support beam (support system to be further described herein). The support beam for the first bench, in one embodiment, is in the approximate center bottom so as to support safely and securely the second bench 40.

Support System:

In the arrangement shown, as one example, system 10 includes a support system 60 (also referred to as “Structural system”, “Stability system”, or simply “support”). Support system 60 is formed of any suitable size, shape, and design, and is configured to support the system at a height of the ground which provides for safe, stabilized use and operation. In this way, a user can more easily access and interact with the system 10.

In the arrangement shown, as one example, support system 60 includes a bench support beam 62, a first support 64, a second support 66, a plurality of ground supports 68, a plurality of footrests 70, footrest supports 72, and footrest attachment features 74. Furthermore, the system also may include operability and adjustability in the footrest features to allow for variation in angle to the bench, distance from the bench horizontally, distance from the bench vertically, and the like.

In the arrangement shown, as one example, the support system 60 includes a first support and a second support which are mounted perpendicular to the bench support beam and the second support of the second bench, thereby providing stable and even support in an elevated position above the ground for a user. Said another way, the bench provides elevated support such that a user does not need to get on the floor or the like.

Adjustable Thoracic Feature:

In the arrangement shown, as one example, system 10 includes an adjustable thoracic feature 100 (also referred to as “adjustable feature”, “thoracic feature”, “alignment feature”, “stretching feature”, “mobility feature”, or simply “spine feature”). Adjustable thoracic feature 100 is formed of any suitable size, shape, and design, and is configured to provide thoracic mobility, stretching, and adjustment while the system 10, as a whole, prevents over stretching and the like.

In the arrangement shown, as one example, adjustable thoracic feature 100 is formed of two primary supports on opposing sides 110 of a first end 102 and a second end 104—the feature having a top 106—which engages with a user—and a bottom 108 which engages with and operably connects to other components of system 10.

In the arrangement shown, as one example, adjustable thoracic feature 100 is configured with a spinal guide feature 112—or open feature for positioning and movement of flow of the posterior portion of the spine to comfortably move through while a user moves in an up and down motion relative to the adjustable thoracic feature 100. Said another way, the spinal guide 112, provides for comfortable movement of the spinous process as a user utilizes the adjustable thoracic feature. In the arrangement shown, a soft indentation forms the spinal guide 112.

Furthermore, and in the arrangement shown as one example, the thoracic feature 100 includes a plurality of alignment features which are semi-spherical in shape and guide the user during stretching, adjustment and the like. While semi-spherical and/or spherical shapes are shown, other shapes are also hereby contemplated for use. Furthermore, the thoracic feature 100 also includes an attachment feature for attaching the thoracic feature 100 to the rest of system 10 and an adjustment feature 118 for angle orientations, vertical changes, horizontal changes, and the like.

In one arrangement, as one example, the adjustable thoracic feature 100, is shown on the cranial side of the first bench having a support beam and base with the support beam being perpendicular to and centered through an opening in the bench. In one arrangement, the adjustable fastener and/or adjustment feature of the thoracic feature 100 operably attaches the thoracic feature to the bench support beam—such that the thoracic feature 100 can move vertically, horizontally, and the like.

In the arrangement shown, as one example, the thoracic component guide features 112 are formed of a soft and/or padded material for comfort and the like.

Other Features:

Footrests: In the arrangement shown, as one example, system 10 includes a plurality of footrests. These footrests are positioned and formed as a pair of footrests which provide a platform for foot support to aid in the effectiveness of stretching and alignment provided by system 10. Furthermore, these components are generally shown at an angle, which is an angle to be effective in support.

In the arrangement shown, as one example, system 10 may also include an incline feature, a plurality of locking mechanisms, a rotational feature, an adjustable footrest feature, an interchangeable material, an interchangeable material attachment feature, a plurality of feet on the supports which aid in grip and the like, among other components, features, and functionality.

In addition to the above identified features, options, controls, and components, system 10 may also include other features and functionalities, among other options, controls, and components.

In Operation:

Various methods of use are described herein which include a user laying down on the bench and stretching, aligning, and the like in a safe and effective manner.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. An adjustable thoracic bench system, comprising:
a first bench;
the first bench extending a length from a first end to a second end between opposing sides;
the first bench having a top and a bottom;
the first bench having a padding;
the first bench having a plurality of attachment features;
the first bench having a plurality of adjustment features;
wherein the adjustment features provide for changing the first bench to an angled position;
a second bench;
the second bench extending a length from a first end to a second end between opposing sides;
the second bench having a top and a bottom;
the second bench having a padding;
the second bench having a plurality of attachment features;
a support system;
the support system wherein the attachment features of the first bench secure the first bench to the support system;
wherein the attachment features of the second bench secure the first bench to the support system;
the support system having a first bench support beam;
the support system having a second bench support beam;
the support system having a plurality of ground supports; wherein the first bench support beam is attached to the plurality of ground supports;
wherein the second bench support beam is attached to the plurality of ground supports;
wherein the plurality of ground supports engage a ground surface and support the first bench and second bench structurally a distance from the ground surface;
wherein the support system forms a bench shape; an adjustable thoracic feature;
the adjustable thoracic feature extending a length from a first end to a second end between opposing side;
the adjustable thoracic feature having a top and a bottom;
the adjustable thoracic feature having a spinal guide;
the spinal guide having a curved soft surface;
the spinal guide positioned between a first alignment feature and a second alignment feature.

2. The system of claim 1, further comprising:
an incline feature.

3. The system of claim 1, further comprising:
a locking mechanism.

4. The system of claim 1, further comprising:
a rotational feature.

5. The system of claim 1, further comprising:
an adjustable footrest feature.

6. The system of claim 1, further comprising:
a plurality of support feet;
wherein the plurality of support feet are attached to the ground support to prevent slippage of the ground supports when in contact with a surface.

7. The system of claim 1, further comprising:
wherein the adjustment features provide for raising and lowering the first bench in approximate spaced relation to a floor surface;
wherein the adjustment features provide for twisting the first bench relative to the second bench; wherein twisting the first bench is a rotation about a center axis extending from the first end to the second end in approximate parallel relation to the opposing sides.

8. The system of claim 1, further comprising:
wherein the padding of the first bench is removably attached to the top of the first bench.

9. The system of claim 1, further comprising:
wherein the padding of the second bench is removably attached to the top of the second bench.

10. The system of claim 1, further comprising:
the second bench having a plurality of adjustment features;
wherein the adjustment features provide for changing the second bench to an angled position;
wherein the adjustment features provide for raising and lowering the second bench in approximate spaced relation to a floor surface.

11. The system of claim 1, further comprising:
a first footrest;
the first footrest have a foot support surface;
the foot support surface angled in approximate relation to the support system;
the foot support surface attached to support structures of the support system;
wherein the first footrest provides a surface such that a user can comfortably position themselves during use;
a second footrest;
the second footrest have a foot support surface;
the foot support surface of the second footrest angled in approximate relation to the support system;
the foot support surface of the second footrest attached to support structures of the support system;
wherein the second footrest provides a surface such that a user can comfortably position themselves during use.

12. The system of claim 1, further comprising:
the first alignment feature shaped approximately as a hemispherical shape;
the second alignment feature shaped approximately as a hemispherical shape.

13. The system of claim 1, further comprising:
the adjustable thoracic feature having a base plate;
wherein the first alignment feature, the second alignment feature, and the spinal guide are removably attached to the base plate.

14. The system of claim 1, further comprising:
the adjustable thoracic feature having a base plate;
wherein the first alignment feature, the second alignment feature, and the spinal guide are removably attached to the base plate;
wherein the base plate is attached to a base plate support feature;
wherein the base plate support feature is operably connected to the support system.

15. The system of claim 1, further comprising:
the adjustable thoracic feature having a base plate;
wherein the first alignment feature, the second alignment feature, and the spinal guide are removably attached to the base plate;
wherein the base plate is attached to a base plate support feature;
wherein the base plate support feature is operably connected to the support system;
the adjustable thoracic feature having a plurality of attachment features;
wherein the plurality of attachment features can be used to affix the adjustable thoracic feature to various surface types.

16. The system of claim 1, further comprising:
the adjustable thoracic feature having an adjustment feature;
wherein the adjustment feature is operably connected to the support system;
wherein the adjustment feature of the adjustable thoracic feature is operably connected to the support system such that the adjustable feature can cause the adjustable thoracic feature to move vertically and lock in place at various locations in a vertical orientation to the support system.

17. A thoracic mobility system, comprising:
an adjustable thoracic feature;
the adjustable thoracic feature extending a length from a first end to a second end between opposing side;
the adjustable thoracic feature having a top and a bottom;
the adjustable thoracic feature having a spinal guide;
the spinal guide having a curved soft surface;
the spinal guide positioned between a first alignment feature and a second alignment feature;
the first alignment feature shaped approximately as a hemispherical shape;
the second alignment feature shaped approximately as a hemispherical shape.

18. The system of claim 17, further comprising:
the adjustable thoracic feature having a base plate;
wherein the first alignment feature, the second alignment feature, and the spinal guide are removably attached to the base plate;
wherein the base plate is attached to a base plate support feature;
wherein the base plate support feature is operably connected to the support system.

19. The system of claim 17, further comprising:
the first alignment feature shaped approximately as a hemispherical shape;
the second alignment feature shaped approximately as a hemispherical shape.

20. A method of adding mobility to the thoracic spine, comprising the steps:
providing a first bench and a second bench operably connected to a support system;
wherein the support system is in the general shape of a bench;
providing a thoracic adjustment feature; the thoracic adjustment feature having a spinal guide, a first alignment feature, a second alignment feature;
lying face up on the first bench and the second bench;
moving over the thoracic adjustment feature to add mobility to a thoracic portion of a spine of a user; wherein moving over the thoracic adjustment feature keeps the thoracic spine within a comfortable range of motion.
